(19) United States
(12) Patent Application Publication
(10) Pub. No.: US 2026/0316743 A1
(43) Pub. Date: Oct. 15, 2026

(54) MINIMUM AND MAXIMUM TORQUE CAPABILITY FOR TRANSMISSION TORQUE INTERVENTIONS

(71) Applicant: JAGUAR LAND ROVER LIMITED, Warwickshire (GB)

(72) Inventors: Romain LACROISILLE, Whitley, Coventry, Warwickshire (GB); Olivier ROQUES, Whitley, Coventry, Warwickshire (GB); Gareth JONES, Whitley, Coventry, Warwickshire (GB); Giuseppe FAVORITO, Whitley, Coventry, Warwickshire (GB); David PARRY, Whitley, Coventry, Warwickshire (GB)

(21) Appl. No.: 19/484,958

(22) PCT Filed: May 14, 2024
(86) PCT No.: PCT/EP2024/063251

§ 371 Date: Nov. 17, 2025

(30) Foreign Application Priority Data
May 17, 2023 (GB) 2307314.1

(51) Int. Cl. B60W 20/15; B60W 10/06; B60W 10/08

(52) U.S. Cl. CPC B60W 20/15; B60W 10/06; B60W 10/08; B60W 2510/0275; B60W 2710/0666; B60W 2710/083

(57) ABSTRACT

Aspects of the present invention relate to a control system, a vehicle, a method, and computer readable instructions. The control system is suitable for managing the torque of a vehicle. The control system comprises one or more controllers, and is configured to receive, at the one or more controllers, torque availability data representative of an amount of torque available for supply by a propulsion system of the vehicle, and to calculate, by the one or more controllers, at least one of an upper limit of the torque available for torque intervention based on the torque availability data, or a lower limit of the torque available for torque intervention based on the torque availability data. Subsequently, when the control system receives, at the one or more controllers, a torque intervention request comprising a request to either increase or decrease the torque supplied by the propulsion system of the vehicle; the one or more controllers determines whether the request to increase or decrease the torque supplied by the propulsion system of the vehicle exceeds the at least one of the upper limit or the lower limit of the torque available for supply by the propulsion system of the vehicle. The torque intervention request can then be adjusted such that the request to either increase or decrease the torque supplied by the propulsion system of the vehicle does not exceed the at least one of the upper limit or the lower limit of the torque available for supply by the propulsion system of the vehicle; and implemented to increase or decrease the torque supplied by the propulsion system of the vehicle.

### TECHNICAL FIELD

The present disclosure relates to a control system for managing transmission torque interventions of a vehicle. Aspects of the invention relate to a control system and to a method for managing such interventions.

### BACKGROUND

It is known to provide systems in vehicles that provide torque from a powertrain, or propulsion system, of the vehicle to drive the vehicle. Conventionally, the transmission of a vehicle may receive a request to change the torque supplied by the propulsion system of the vehicle when the vehicle is in motion. Such requests to change the torque supplied by the propulsion system may be described as being a request for torque intervention, and may occur as a consequence of, for example, a gear shift. However, if the amount of torque available for supply from the propulsion system is inadequate to meet the amount of torque requested in the requested torque intervention, then the gear shift quality may be degraded and the drivability of the vehicle may be compromised. It is an aim of the present invention to address one or more of these disadvantages.

### SUMMARY OF THE INVENTION

Aspects and embodiments of the invention provide a control system, a system, a vehicle, a method and computer readable instructions as claimed in the appended claims.

According to an aspect of the present invention there is provided a control system for managing the torque of a vehicle, the control system comprising one or more controllers, and wherein the control system is configured to: receive, at the one or more controllers, torque availability data representative of an amount of torque available for supply by a propulsion system of the vehicle within a predetermined time period; and calculate, by the one or more controllers, at least one of an upper limit of the torque available for torque intervention during the predetermined time period based on the torque availability data, or a lower limit of the torque available for torque intervention during the predetermined time period based on the torque availability data.

This aspect of the present invention may also include the control system being further configured to: receive, at the one or more controllers, a torque intervention request comprising a request to either increase or decrease the torque supplied by the propulsion system of the vehicle during the predetermined time period; determine, by the one or more controllers, whether the request to increase or decrease the torque supplied by the propulsion system of the vehicle during the predetermined time period exceeds the at least one of the upper limit or the lower limit of the torque available for supply by the propulsion system of the vehicle;

This aspect of the present invention may also include the control system being further configured to: adjust, by the one or more controllers and based on the determination, the torque intervention request such that the request to either increase or decrease the torque supplied by the propulsion system of the vehicle does not exceed the at least one of the upper limit or the lower limit of the torque available for supply by the propulsion system of the vehicle during the predetermined time period. This aspect of the present invention may also include the control system being further configured to: implement, by the one or more controllers, the adjusted torque intervention request to increase or decrease the torque supplied by the propulsion system of the vehicle during the predetermined time period. In this way, the control system is able to implement a torque intervention (e.g. a gear shift) that more closely reflects the torque that is available for supply by the powertrain of the vehicle. As a result, the quality of a subsequent torque intervention (e.g. gear shift) and the drivability of the vehicle is improved, or maintained, compared with a torque intervention that requests more torque than the powertrain is currently able to provide (i.e. the powertrain under-delivering torque during a torque intervention).

Optionally, the one or more controllers comprises a first control module and a second control module, where the first control module is configured to receive the torque availability data and calculate the at least one of the upper limit or the lower limit of the torque available for supply by the propulsion system of the vehicle based on the torque availability data. The second control module is optionally configured to do one or more of: receive the torque intervention request, determine whether the request to increase or decrease the torque supplied by the propulsion system of the vehicle during the predetermined time period exceeds the at least one of the upper limit or the lower limit, adjust the torque intervention request based on the determination, and implement the adjusted torque intervention request.

Optionally, the torque availability data comprises at least one of an upper limit of the torque that can be supplied by an electric motor of the propulsion system of the vehicle during the predetermined time period, and a lower limit of the torque that can be supplied by the electric motor of the propulsion system of the vehicle during the predetermined time period; and the control system is further configured to calculate, by the first control module, at least one of: the upper limit of the torque available for torque intervention based upon the upper limit of the torque that can be supplied by the electric motor of the propulsion system of the vehicle during the predetermined time period; and the lower limit of the torque available for torque intervention based upon the lower limit of the torque that can be supplied by the electric motor of the propulsion system of the vehicle during the predetermined time period.

In this way, and where the vehicle in question has an electric motor (or electric machine), the control system is able to calculate the upper and/or lower limits that can supplied specifically by the electric motor (or electric machine). This further allows the control system to implement a received torque intervention request that reflects the torque that is available for supply by the electric machine of the vehicle. As a result, the quality of a subsequent torque intervention (e.g. gear shift) and the drivability of the vehicle is further improved, or maintained, compared with a torque intervention that requests more torque than the powertrain is currently able to provide (i.e. the electric machine under-delivering torque during a torque intervention).

Optionally, the torque availability data comprises at least one of an upper limit of the torque that can be supplied by an engine of the propulsion system of the vehicle during the predetermined time period, and a lower limit of the torque that can be supplied by the engine of the propulsion system of the vehicle during the predetermined time period; and the control system is further configured to calculate, by the first control module, at least one of: the upper limit of the torque available for torque intervention based upon the upper limit of the torque that can be supplied by the engine of the propulsion system of the vehicle during the predetermined time period; and the lower limit of the torque available for torque intervention based upon the lower limit of the torque that can be supplied by the engine of the propulsion system of the vehicle during the predetermined time period.

In this way, and where the vehicle in question has an engine (e.g. an internal combustion engine), the control system is able to calculate the upper and/or lower limits that can supplied specifically by the engine (e.g. the internal combustion engine). This further allows the control system to implement a received torque intervention request that reflects the torque that is available for supply by the engine (e.g. the internal combustion engine) of the vehicle. As a result, the quality of a subsequent torque intervention (e.g. gear shift) and the drivability of the vehicle is further improved, or maintained, compared with a torque intervention that requests more torque than the engine (e.g. the internal combustion engine) is currently able to provide (i.e. the engine under-delivering torque during a torque intervention).

Optionally, the torque availability data comprises a state of a clutch of the vehicle during the predetermined time period; and the control system is further configured to calculate, by the first control module, at least one of: the upper limit of the torque available for torque intervention based upon the state of the clutch during the predetermined time period; and the lower limit of the torque available for torque intervention based upon the state of the clutch during the predetermined time period.

In this way, the control system is able to calculate the upper and/or lower limits based on the current state of the clutch of the vehicle. By accounting for the current state of the clutch of the vehicle, this improves how the calculated upper and/or lower limits reflect the current ability of the powertrain of the vehicle to deliver torque. As a result, the quality of a subsequent torque intervention (e.g. gear shift) and the drivability of the vehicle is further improved, or maintained.

Optionally, wherein the control system is further configured to: receive, at the second control module, a stability control intervention demand to either increase or decrease the torque supplied by the propulsion system of the vehicle during the predetermined time period; adjust, by the second control module, the at least one of the upper limit and the lower limit of the torque available for torque intervention during the predetermined time period such that the at least one of the upper limit and the lower limit of the torque available for torque intervention during the predetermined time period does not exceed the demand to either increase or decrease the torque supplied by the propulsion system of the vehicle in the stability control intervention.

The control system may optionally be configured to implement, by the second control module, the stability control intervention demand to increase or decrease the torque supplied by the propulsion system of the vehicle during the predetermined time period. In this way, by adjusting the at least one or the upper and/or lower limits based on a receive stability control intervention, the control system is able to minimise the risk of a loss of stability of the vehicle (for example when the vehicle is experiencing a reduction in traction due to the current surface the vehicle is driving on). Consequently, safety in such scenarios is improved.

Optionally, the control system is further configured to: calculate the at least one of the upper limit of the torque available for torque intervention during the predetermined time period and the lower limit of the torque available for torque intervention during the predetermined time period as a relative value of the absolute torque that can be supplied by the propulsion system of the vehicle during the predetermined time period. In this way, the calculated at least one of the upper and/or lower limits is provided in a format that is more straightforward for the control system, or further systems of the vehicle, to interpret. As such, the calculated upper and/or lower limits may be processed by the control system, or further systems of the vehicle, more efficiently.

According to an aspect of the present invention there is provided a vehicle comprising the control system of the previous aspect.

According to an aspect of the present invention there is provided a method for managing the torque of a vehicle, the method comprising: receiving torque availability data representative of an amount of torque available for supply by a propulsion system of the vehicle within a predetermined time period; and calculating at least one of an upper limit of the torque available for torque intervention during the predetermined time period based on the torque availability data, or a lower limit of the torque available for torque intervention during the predetermined time period based on the torque availability data.

This aspect of the present invention may also include the method further comprising: receiving the at least one of the upper limit and the lower limit of the torque available for torque intervention during the predetermined time period; receiving a torque intervention request comprising a request to either increase or decrease the torque supplied by the propulsion system of the vehicle during the predetermined time period; and determining whether the request to increase or decrease the torque supplied by the propulsion system of the vehicle during the predetermined time period exceeds the at least one of the upper limit or the lower limit of the torque available for supply by the propulsion system of the vehicle.

This aspect of the present invention may also include the method further comprising: adjusting, based on the determination above, the torque intervention request such that the request to either increase or decrease the torque supplied by the propulsion system of the vehicle does not exceed the at least one of the upper limit or the lower limit of the torque available for supply by the propulsion system of the vehicle during the predetermined time period. This aspect of the present invention may also include the method further comprising: implementing the adjusted torque intervention request to increase or decrease the torque supplied by the propulsion system of the vehicle during the predetermined time period.

Optionally, the torque availability data comprises at least one of an upper limit of the torque that can be supplied by an electric motor of the propulsion system of the vehicle during the predetermined time period, and a lower limit of the torque that can be supplied by the electric motor of the propulsion system of the vehicle during the predetermined time period. The method may then further comprise at least one of: calculating the upper limit of the torque available for torque intervention based upon the upper limit of the torque that can be supplied by the electric motor of the propulsion system of the vehicle during the predetermined time period; and calculating the lower limit of the torque available for torque intervention based upon the lower limit of the torque that can be supplied by the electric motor of the propulsion system of the vehicle during the predetermined time period.

Optionally, the torque availability data comprises at least one of an upper limit of the torque that can be supplied by an engine of the propulsion system of the vehicle during the predetermined time period, and a lower limit of the torque that can be supplied by the engine of the propulsion system of the vehicle during the predetermined time period. The method may then further comprise at least one of: calculating the upper limit of the torque available for torque intervention based upon the upper limit of the torque that can be supplied by the engine of the propulsion system of the vehicle during the predetermined time period; and calculating the lower limit of the torque available for torque intervention based upon the lower limit of the torque that can be supplied by the engine of the propulsion system of the vehicle during the predetermined time period.

Optionally, the torque availability data comprises a state of a clutch of the vehicle during the predetermined time period. The method may then further comprise at least one of: calculating the upper limit of the torque available for torque intervention based upon the state of the clutch during the predetermined time period; and
calculating the lower limit of the torque available for torque intervention based upon the state of the clutch during the predetermined time period.

Optionally, the method further comprises: receiving a stability control intervention demand to either increase or decrease the torque supplied by the propulsion system of the vehicle during the predetermined time period;
adjusting the at least one of the upper limit and the lower limit of the torque available for torque intervention during the predetermined time period such that the at least one of the upper limit and the lower limit of the torque available for torque intervention during the predetermined time period does not exceed the demand to either increase or decrease the torque supplied by the propulsion system of the vehicle in the stability control intervention.

The method may then optionally include implementing the stability control intervention demand to increase or decrease the torque supplied by the propulsion system of the vehicle during the predetermined time period based on the adjusted at least one of the upper limit and lower limit of the torque available for torque intervention during the predetermined time period.

Optionally, the method may further comprise: calculating the at least one of the upper limit of the torque available for torque intervention during the predetermined time period and the lower limit of the torque available for torque intervention during the predetermined time period as a relative value of the absolute torque that can be supplied by the propulsion system of the vehicle during the predetermined time period.

The same advantages of this method are also present as described above in relation to the preceding aspects. The method may comprise the further restrictions of any of the preceding aspects. For example, the method may further comprise the control system and/or any of the embodiments thereof. Likewise, the method may comprise the vehicle.

According to an aspect of the present invention there is provided computer readable instructions which, when executed by a computer, are arranged to perform a method according to the previous aspect.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle in accordance with embodiments of the invention;

FIG. 2 shows a schematic example of a transmission and a powertrain of a vehicle in accordance with the embodiment of FIG. 1;

FIG. 3 shows a control system in accordance with an embodiment of the invention;

FIG. 4 shows an example plot of a torque intervention according to some embodiments;

FIG. 5 shows a flowchart of the calculation of the upper limit of torque availability according to some embodiments;

FIG. 6 shows a flowchart of the calculation of the lower limit of torque availability according to some embodiments; and

FIG. 7 shows a flowchart of the function of a control system according to some embodiments.

### DETAILED DESCRIPTION

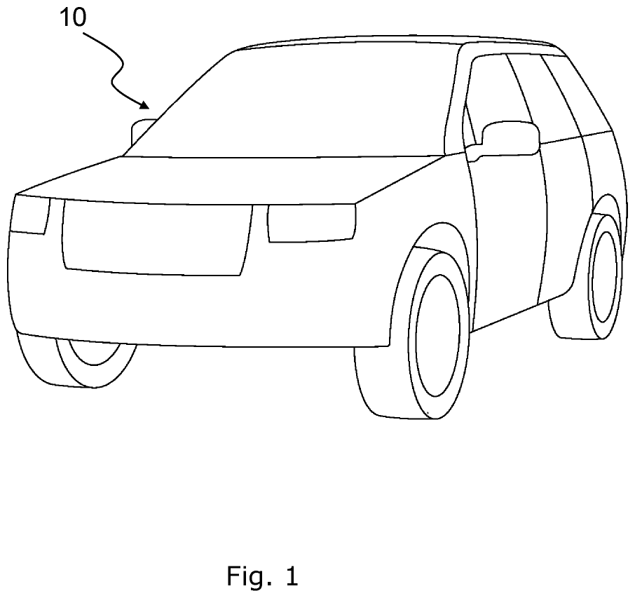

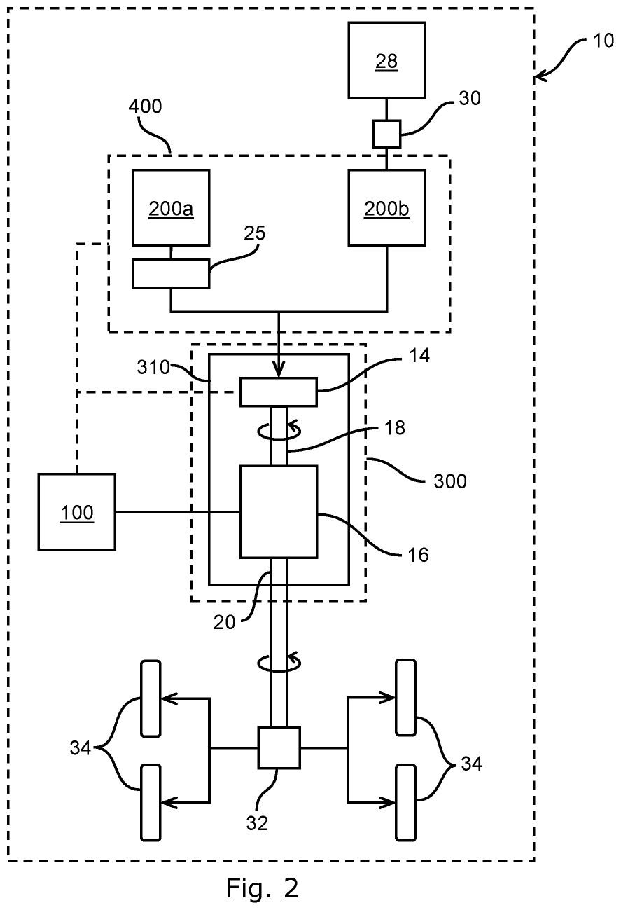

A control system 100 in accordance with an embodiment of the present invention is described herein with reference to the accompanying FIGS. 1 to 9. The control system 100 is suitable for controlling a powertrain of a vehicle 10 with a plurality of actuators 200. As shown in FIG. 2, the control system 100 is installed in a vehicle 10.

The vehicle 10 in accordance with an embodiment of the present invention is described herein with reference to the accompanying FIG. 1. In some, but not necessarily all examples, the vehicle 10 is a passenger vehicle, also referred to as a passenger car or as an automobile. In other examples, embodiments of the invention can be implemented for other applications, such as commercial vehicles.

FIG. 2 schematically includes an illustrated example of at least part of a powertrain 400 of the vehicle 10.

In this example, the vehicle powertrain 400 comprises a plurality of torque actuators 200 (which may also be referred to generically as power sources) which are selectively operable for the purpose of providing drive torque for accelerating or decelerating the vehicle 10. A torque source refers to a prime mover, such as an internal combustion engine 200a, an electric machine 200b such as a traction motor, or the like.

In the illustrated example, the plurality of actuators 200 of the powertrain 400 comprises at least an internal combustion engine 200a (which may include an engine clutch 25) and an electric machine (or electric motor) 200b. In further examples other actuators or torque sources may be present.

The electric machine 200b is an electric motor arranged to convert electrical energy into kinetic energy in the form of mechanical torque and is also arranged to convert kinetic energy in the form of kinetic energy into electrical energy. The electric machine 200b may be an alternating current induction motor or a permanent magnet motor, or another type of suitable known electric machine. The electric machine 200b is a traction motor configured to enable at least an electric mode comprising electric-only driving. That is, the electric machine 200b may, in some scenarios, drive the vehicle 10 by itself (i.e. without an engine). Another term for the electric machine 200b is an electric drive unit (EDU).

The vehicle 10 comprises a transmission system 300 comprising a transmission 310. The transmission 310 comprises an input clutch 14 (also generically known as a coupling element) which transfers torque output by the plurality of torque actuators 200 of the powertrain 400 to the transmission input shaft 18. The input clutch 14 may be a wet clutch such as a torque converter or one or more automatically-actuated friction clutches as found in, for example, a dual-clutch transmission.

The transmission 310 also comprises a gear set and accompanying shifting mechanism, referenced in combination as combined gear-shift mechanism 16. The gear set comprises a plurality of gears which are selectively couplable into different gear trains to enable multiple gear ratios between the transmission input shaft 18 and the transmission output shaft 20.

The clutches and their actuators form the shifting mechanism. The shifting mechanism is controlled to establish a selected gear ratio in accordance with a control signal output by the control system 100, alternatively this may be achieved by a second control system within the vehicle 10 connected or connectable to and in communication with the first control system 100 of the present invention.

The control system 100 is also capable of controlling actuation of the input clutch 14.

The transmission output shaft 20 is connected to a final set of gears 32, such as a pinion gear meshed with a ring gear, to transfer torque to the wheel axles and thus the vehicle wheels 34.

In order to store electrical energy for the electric machine 200b, the vehicle 10 comprises an electrical energy storage means 28. The electrical energy storage means 28 can be a traction battery. The traction battery 28 provides a nominal voltage required by electrical power users such as the electric machine 26.

The traction battery 28 may be a high voltage battery. The traction battery 28 may have a voltage and capacity to support electric only driving for sustained distances. The traction battery 28 may have a capacity of several kilowatt-hours, to maximise range. The capacity may be in the tens of kilowatt-hours, or even over a hundred kilowatt-hours.

Although the traction battery 28 is illustrated as one entity, the function of the traction battery 28 could be implemented using a plurality of small traction batteries in different locations on the vehicle 10 in a manner known in the art.

An inverter 30 converts between the DC output of the traction battery 28 and the AC input required for the electric machine 26.

In view of the above description of the vehicle 10, it will be understood that the vehicle 10 may be a full hybrid electric vehicle (HEV). However, in some examples the vehicle 10 may be other than as shown in FIG. 2. The vehicle 10 may be a battery electric vehicle (BEV), a plug-in electric hybrid vehicle (PHEV), a mild hybrid electric vehicle (MHEV), an internal combustion engine vehicle (ICEV) or otherwise.

MHEVs do not have an electric-only mode of propulsion, but the electric machine 200b may be configured to provide assistance such as boosting output torque of the engine 200a. In such vehicles the electric machine 200b may not be sufficiently powerful to drive the vehicle 10 under electric power alone.

BEVs are an electric-only vehicles which are propelled by an electric machine 200b which receives power from an on-board traction battery 28. ICEV are propelled solely by an engine 200a. In such systems any on-board electric machine is used only as a starter-generator.

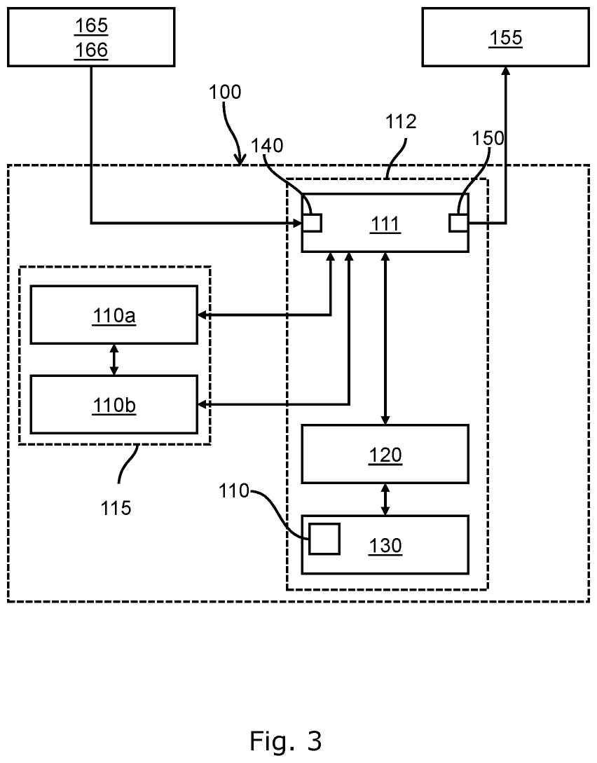

FIG. 3 is an example of the control system 100. The control system comprises one processor 112, although it will be appreciated that this is merely illustrative and that more than one processor 112 may be provided. The processor 112 comprises processing means 120 and memory means 130.

The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The processor 112 comprises an input means 140 and an output means 150. The input means 140 may comprise an electrical input 140 of the processor 112. The output means 150 may comprise an electrical output 340 of the processor 112. The processor 112 may have an interface comprising 111 the input means 140 and output means 150. The input means 140 is arranged to receive a torque intervention request signal 165 from a sensor. The torque intervention request signal 165 is an electrical signal which is indicative of a requirement to perform a torque intervention. The input means 140 is also arranged to receive the one or more input parameters 166.

The control system 100 and steps undertaken by the one or more processors 112 to controlling or managing the torque supplied by the powertrain (or propulsion system) 400 of the vehicle 10. The control system 100 may comprise one or more control modules 110 for controlling or managing the torque supplied by the powertrain (or propulsion system) 400 of the vehicle 10.

The control system 100 may comprise one or more modules 110. The one or more modules 110 of the control system 100 may include a powertrain control module 110a and a transmission control module 110b. In some embodiments, the same function of the powertrain control module 110a and the transmission control module 110b may be carried out by other modules or systems of the vehicle. As such, the powertrain control module 110a and the transmission control module 110b may be respectively referred to as a first control module 110a and a second control module 110b. Alternatively or in addition, in some embodiments the powertrain control module 110a and the transmission control module 110b may be implemented separately or may be implemented are part of a single module. In some embodiments, one or more controllers 115 of the control system 100 may comprise the one or more control modules 110.

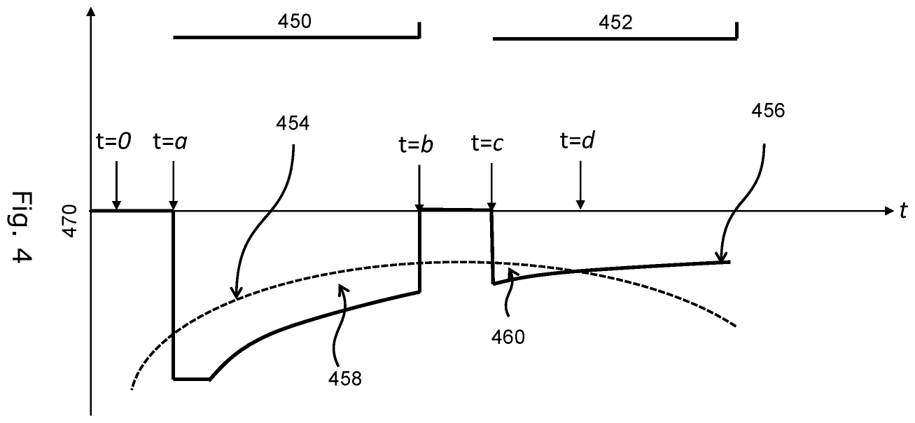

The manner in which the control system 100 controls or manages the torque supplied by the powertrain (or propulsion system) 400 of the vehicle 10 will be discussed in more detail with the aid of FIGS. 4 to 7.

In some embodiments, the control system 100 may also include modules or systems for managing the stability of the vehicle 10 in certain driving conditions. For example, such modules or systems may initiate an increased level of control of the vehicle 10 when it is determined that the vehicle 10 is on surfaces with less grip (for example, icy surfaces, surfaces with excess standing water, or any surface where grip is sufficiently reduced).

In such scenarios, the vehicle stability control module 110d and stability control system 110c of the control system 100 may cause the control system 100 to automatically increase or decrease the torque supplied by the powertrain 400 to ensure that control of the vehicle 10 is maintained in those certain driving conditions. This may take the form of a demand for chassis intervention (which may also be referred to as a stability control intervention or demand for stability intervention).

The control system 100 of the vehicle 10, or another system of the vehicle 10, may continually assess whether a chassis/stability intervention is needed. This assessment may take into account the current state of the control system 100 and/or the current state of the engine clutch (e.g. whether the clutch is open, closed, or slipping). In some embodiments, a demand for chassis/stability intervention may be expressed as a positive or a negative value. In some embodiments, when a demand for chassis/stability intervention is present, or active, this may be prioritised over a torque intervention request (e.g. a gear shift), as will be discussed in more detail below.

The vehicle 10 includes a plurality of torque actuators 200, each torque actuator being a component or element of the powertrain 400 of the vehicle 10 that is able to deliver torque to the transmission 300 of the vehicle 10. The plurality of torque actuators 200 may include one or more of an internal combustion engine 200a, an electric engine (or electric motor) 200b, an engine clutch 200c, or a launch device 200d such as a clutch or torque converter.

Whilst the control system 100 as illustrated in FIG. 3 comprises several specific control modules 110, it will be appreciated that the various components and control modules shown in FIG. 3 are merely illustrative, and may be omitted depending on the specific vehicle 10 in question. For example, if the vehicle 10 is not an electric or hybrid vehicle, then the electric engine 200b may be omitted, or if the vehicle is a wholly electric vehicle 10, the internal combustion engine 200a may be omitted. Similarly, other or additional components or control modules may be included depending on the specific vehicle 10 in question. In addition, and as discussed above, the control modules 110 of the control system 100 may be implemented as part of one or more controllers 115, or as separate control modules of the control system 100.

FIG. 4 shows an example plot of a conventional torque intervention, showing the relative minimum amount of torque that can be supplied by the powertrain 400 over a period of time, as well as a requested decrease in torque over that time period according to a torque intervention request that represents two successive upshifts in gears.

The graph of FIG. 4 can be labelled as follows:

| | |
|---|---|
| 450 | First Gear Upshift |
| 452 | Second Gear Upshift |
| 454 | Relative Powertrain Lower Limit |
| 456 | Relative Torque Intervention Request |
| 458 | First Region of Torque Supply Shortfall |
| 460 | Second Region of Torque Supply Shortfall |
| 470 | Torque supplied by the Powertrain |

During a torque intervention, the torque supplied by the powertrain 400 is increased or decreased to meet a given demand, for instance during a gear shift in the vehicle 10. For example, during a gear shift of the vehicle 10, the transmission 300 sends a request for torque intervention to compensate for the input speed inertia change, to avoid a disturbance from the positive slip created in the transmission. The powertrain 400 then supplies that requested increase in torque.

Whilst the precise form of the gear shift, or indeed a torque intervention in general, may vary depending on the specific circumstances of the torque intervention request, the example plot of FIG. 4 is used to describe the general principles of a torque intervention.

The system torque capability (e.g. the torque that can be delivered by the internal combustion engine, hybrid vehicle battery, inverter, etc.), or the available torque, are likely to vary based on the current system or driving conditions. As a result, when a torque intervention is implemented, there may be insufficient torque available to completely fulfil the torque intervention.

This is shown in FIG. 4 where, during the two successive gear upshifts, there is insufficient torque available to meet the requirements of the torque intervention. At t=0, no torque intervention is taking place and the powertrain 400 is providing a consistent amount of torque to drive the vehicle 10 (since the example plot of FIG. 4 is relative, this is set to zero). At t=a, an upshift in the gears takes place, and a request for torque intervention is received by the powertrain 400 (shown as a solid line in FIG. 4). The size of the increase or decrease in the torque supplied by the powertrain 400 during the request for torque intervention varies over the period the intervention is taking place, and is determined based on the specific circumstances at that time (i.e. each request for torque intervention will have its own specific profile that is dependent on the current circumstances).

However, between t=a and t=b, the size of the requested decrease in the amount of torque supplied by the powertrain 400 is greater than the lower limit of torque that the powertrain can deliver at that time. As a result, between t=a and t=b, the powertrain 400 can only deliver a decrease in torque that is within its current lower limit (shown as a dotted line in FIG. 4), creating a region of torque supply shortfall. Here, it is highlighted that the amount of any increase or a decrease in the torque that can be supplied by the powertrain 400 varies with time based on the current state of the actuators of the powertrain 400, and therefore the lower limit (i.e. The dotted line of FIG. 4) likewise varies with time. This shortfall in the torque that can be supplied by the powertrain 400 compared with the request for torque intervention then negatively affects the quality of the gear shift.

Att=b, the first gear upshift is completed, and the relative torque returns to its previous value (again, this since the example plot of FIG. 4 is relative, this is set to zero).

At t=c, a second upshift in the gears takes place, and a further request for torque intervention is received by the powertrain 400. However, as before, between t=c and t=d, the size of the requested decrease in the amount of torque supplied by the powertrain 400 is greater than the lower limit of torque that the powertrain can deliver at that time. As a result, between t=c and t=d, the powertrain 400 can only deliver a decrease in torque up to its current lower limit (shown as a dotted line in FIG. 4), creating a second region of torque supply shortfall. However, since the size of the requested decrease in torque is less than in the first gear upshift, this second region of torque supply shortfall is shorter and shallower, and may have less of a negative impact on the quality of the gear upshift compared with the first region of torque supply shortfall. In some circumstances, such a short and shallow region of torque supply shortfall may therefore be acceptable, or may nonetheless still result in a degraded gear shift quality.

After t=d the powertrain is able to supply the requested decrease (i.e. because the size of the requested decrease after t=d is within the lower limit of the torque available for supply by the powertrain 400 at that time).

Such a scenario (where the powertrain is currently unable to meet the requested change in torque) may arise for a number of reasons. As a non-limiting example, the high voltage battery of the vehicle may be full, such that the minimum torque capability is reduced or restricted since the battery cannot be charged any further (or further charging would be inadequate). As a further non-limiting example, the high voltage battery of the vehicle may be very cold, leading to reduced power availability. As a further non-limiting example, the current temperature of the engine of the vehicle may have an effect on the internal friction and minimum value of fuel-cut torque (i.e. when no fuel is currently being injected into the engine). As a further non-limiting example, the engine of the vehicle may or may not be on boost via its turbocharger, affecting how much instant torque can be delivered.

This then results in the powertrain under delivering, or ignoring, transmission interventions, and alters the driveability of the vehicle (due to shift control and quality), resulting in gear shift quality degradation and possibly interventions that are missed entirely.

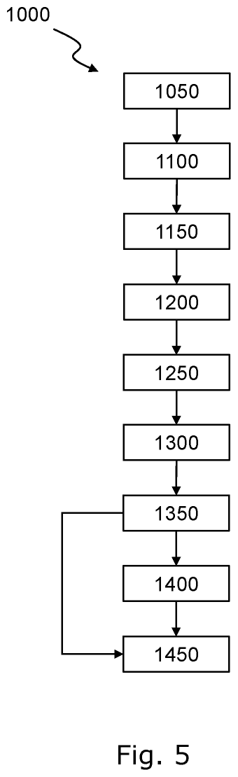

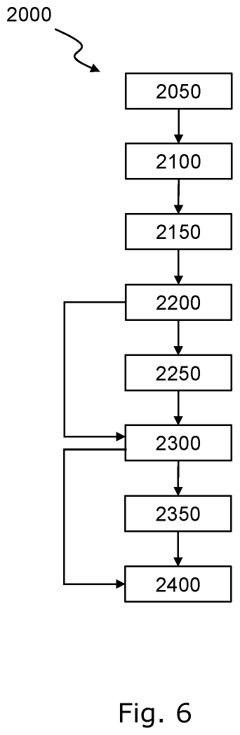

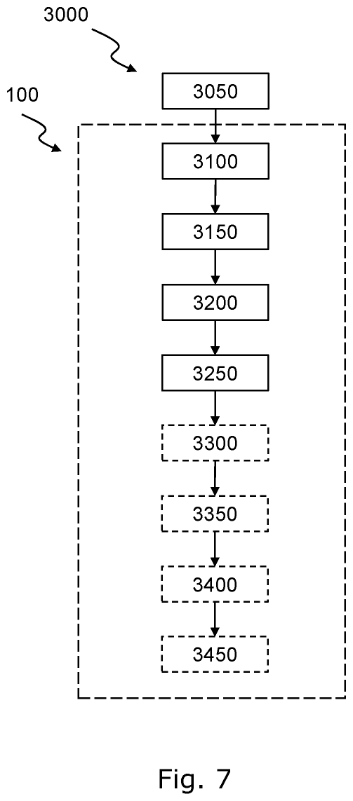

The control system 100 of the present invention is configured to manage the torque of the vehicle 10 to reduce or remove the above identified problems. In particular, the control system 100 is configured to calculate one or both of the current upper and lower limits of the torque available for supply by the powertrain 400 of the vehicle 10 (as discussed with reference to FIGS. 5 and 6), such that a requested torque intervention can be adjusted to fall within (or between) the calculated one or both of the upper and lower limits (as discussed with reference to FIG. 7).

This therefore allows the transmission to better control each gear shift, since the transmission is aware of what torque can be delivered by the powertrain 400, rather than the transmission requesting an amount of torque that cannot currently be fulfilled by the powertrain 400 (thereby affecting the quality of the gear shift).

In more detail, the powertrain control module 110a of the control system 100 is configured to receive torque availability data 500 from each of the plurality of torque actuators 200. The torque availability data 500 comprises the current amount of torque available for supply by the associated torque actuator of the powertrain 400 of the vehicle 10.

In some embodiments, the torque availability data 500 may be collected for each actuator of the plurality of actuators 200 in real time (i.e. outside of a period of gear shifting). Here, each torque actuator of the plurality of torque actuators 200 may collect torque availability data 500 continuously, for instance every time a certain predetermined period of time has elapsed. For example, each of the plurality of torque actuators 200 may collect torque availability data 500 every 200 milliseconds. In another example, each of the plurality of torque actuators 200 may collect torque availability data 500 every 2 seconds. Here, it will be understood that the predetermined period of time in which the torque availability data 500 is collected may be chosen to be any suitable length of time.

The control system 100 then provides the torque availability data 500 to the powertrain control module 110a. The powertrain control module 110a is then able to use the torque availability data 500 to calculate an upper limit 550a (or a maximum, or an upper threshold) of the torque available for torque intervention during the predetermined time period. For example, the powertrain control module 110a may calculate that the upper limit 550a of currently available torque that can be supplied by the plurality of torque actuators 200 of the powertrain 400 in the current predetermined time period is 800 Nm.

The powertrain control module 110a may also then use the torque availability data 500 to calculate a lower limit (or a minimum, or a lower threshold) 550b of the torque available for torque intervention during the predetermined time period based on the torque availability data 500. For example, the powertrain control module 110a may calculate that the lower limit 550b of currently available torque that can be supplied by the plurality of torque actuators 200 of the powertrain 400 in the current predetermined time period is 50 Nm.

Therefore, the calculated upper limit 550a, or maximum currently available torque, reflects the maximum torque that can be supplied by the plurality of torque actuators 200 of the powertrain 400 during that current predetermined time period. Similarly, the calculated lower limit 550b, or minimum currently available torque, reflects the minimum torque that can be supplied by the plurality of torque actuators 200 of the powertrain 400 during that current predetermined time period.

It will be understood that, in all embodiments, the control system 100 may calculate one or both of the upper limit 550a and the lower limit 550b.

In some embodiments, each of the upper limit 550a and lower limit 550b of torque availability may be expressed as a positive or negative value.

In further embodiments, each of the upper limit 550a and lower limit 550b of torque availability may be expressed as an absolute value of the torque that can currently be supplied by the powertrain 400 (for example, in Nm). This means that the upper limit 550a and the lower limit 550b includes the current torque being supplied by the powertrain 400 of the vehicle 10, as well as the torque that can be added or removed from that currently supplied value.

For example, if the torque currently supplied by the powertrain 400 is +300 Nm, then the current absolute upper limit 550a may be +350 Nm (i.e. 50 Nm of additional torque), and the current absolute lower limit 550b may be +220 Nm (i.e. −80 Nm of additional torque).

In some embodiments, each of the upper limit 550a and lower limit 550b of torque availability may alternatively be expressed as a relative value. Here, each of the upper limit 550a and the lower limit 550b of torque availability may be expressed as a relative value such that the initial current torque value is set to zero (i.e. no intervention is taking place). The upper limit 550a and the lower limit 550b are then expressed as the relative change in torque that can be delivered by the powertrain 400.

For example, if the torque currently supplied by the powertrain 400 is +300 Nm, this is considered to be zero when expressing the relative upper limit 550a and the relative lower limit 550b, such that the current relative upper limit 550a may be +50 Nm, and current the relative lower limit 550b may be −80 Nm.

Once the upper limit 550a and the lower limit 550b are calculated by the powertrain control module 110a, the powertrain control module 110a may send the calculated upper limit 550a and lower limit 550b to the transmission control module 110b.

As a result, the transmission control module 110b periodically receives the currently available upper limit 550a and lower limit 550b of torque that is available for supply by the powertrain 400 as a potential torque intervention. It will be understood that the frequency with which the transmission control module 110a receives the current upper limit 550a and the current lower limit 550b is dependent upon the predetermined time period chosen. Therefore, if more up-to-date values of the currently available upper limit 550a and the currently available lower limit 550b of torque availability are desired, then a shorter predetermined time period should be chosen (such that the powertrain control module 110a receives torque availability data 500, and calculates the current upper limit 550a and the current lower limit 550b, more frequently).

After the transmission control module 110b has received the most recent values for the upper limit 550a and the lower limit 550b, the transmission control module may receive a torque intervention request (for example, immediately prior to a gear shift). Alternatively, in some embodiments, the transmission control module 110b may generate the torque intervention request. For example, the transmission control module 110b generates the torque intervention request in response to receiving a signal indicating a gear shift.

The transmission control module 110b may then determine whether the torque that is requested in the received torque intervention request exceeds the upper limit 550a or the lower limit 550b received from the powertrain control module 110a. If it is determined that the upper limit 550a or the lower limit 550b would be exceeded if the torque intervention request were implemented, then the transmission control module 110b may adjust the torque intervention request such that the upper limit 550a or the lower limit 550b is not exceeded.

As an example, in one scenario (and as discussed above), the powertrain control module 110a and the transmission control module 110b may be components of one or more controllers 115 of the control system 100. Based on the most recent torque availability data 500 (which may be received at the beginning of a predetermined time period of every 0.3 seconds), the powertrain control module 110a may calculate the relative upper limit 550a of the torque currently available to be supplied by the powertrain 400 to be +50 Nm. The powertrain control module 110a may also calculate the relative lower limit 550b of the torque currently available to be supplied by the powertrain 400 to be −80 Nm. The powertrain control module 110a may then output these values to the transmission control module 110b.

Then, before receiving updated values of the calculated upper limit 550a and lower limit 550b from the powertrain control module 110a at the start of the next 0.3 second predetermined time period, the transmission control module 110b may receive a torque intervention request. The torque intervention request may include a request to increase the torque supplied by the powertrain by +80 Nm (e.g. due to an imminent downshift in gears).

The transmission control module 110b may then determine whether the change in torque requested in the torque intervention request exceeds the upper limit 550a or the lower limit 550b of the torque that is currently available for supply by the powertrain 400. In this scenario, the transmission control module 110b determines that the requested increase in torque of +80 Nm would exceed the upper limit 550a of torque current available for supply of +50 Nm. Therefore, there is currently insufficient torque available for supply by the powertrain 400 to fulfil the torque intervention request, affecting the quality of the gear shift and the drivability of the vehicle 10.

The transmission control module 110b may then adjust the torque intervention request such that the upper limit 550a of available torque would not be exceeded if the torque intervention request were implemented. In this scenario, the torque intervention request is adjusted by the transmission control module 110b to request an increase of +50 Nm rather than the previously requested +80 Nm.

As a result, the adjusted torque intervention request can then be implemented and the powertrain 400 is able to supply the additional +50 Nm of torque, such that the quality of the gear shift and the drivability of the vehicle 10 is maintained.

In some embodiments, the control system 100 may receive a demand for stability control intervention. Here, the stability control intervention may demand that the torque supplied by the powertrain 400 is increased or reduced by a given amount to ensure control of the vehicle is maintained. For example, it may be determined (either by the control system 100 or by another system of the vehicle 10) that the vehicle 10 is at risk of losing traction with the current surface it is driving on.

In such scenarios, the control system 100 may override one or both of a calculated upper limit 550a or lower limit 550b to meet the demand for stability control intervention. For example, if the demand for stability control intervention demands that the powertrain 400 set a limit of the amount of torque that can be supplied (either as an increase or a decrease in torque) that is less than the calculated upper limit 550a or more than the calculated lower limit 550b, then the control system 100 may adjust the upper limit 550a and/or lower limit 550b such that the adjusted upper limit 550a and/or adjusted lower limit 550b fall within the maximum and minimum limits set in the demand for stability control intervention.

As an example, based on the most recent torque availability data 500 (which may be received at the beginning of a predetermined time period, for example every 0.1 seconds), the powertrain control module 110a may calculate the relative upper limit 550a of the torque currently available to be supplied by the powertrain 400 to be +120 Nm. The powertrain control module 110a may also calculate the relative lower limit 550b of the torque currently available to be supplied by the powertrain 400 to be −90 Nm. The powertrain control module 110a may then output these values to the transmission control module 110b.

Then, before receiving updated values of the calculated upper limit 550a and lower limit 550b from the powertrain control module 110a at the start of the next predetermined time period (for example, the next 0.1 seconds), the transmission control module 110b or, in some embodiments, the powertrain control module 110a may receive a demand for stability control intervention. The demand for stability control intervention may include setting a maximum limit of +10 Nm of torque supplied by the powertrain 400 (e.g., due to an assessed risk of a loss of traction).

The transmission control module 110b (or, in some embodiments, the powertrain control module 110a) may then determine whether the maximum limit of torque included in the demand for stability control intervention falls below the upper limit 550a of the torque that is currently available for supply by the powertrain 400. In this scenario, the transmission control module 110b or the powertrain control module 110a determines that the requested maximum limit of +10 Nm in torque would be below the upper limit 550a of +120 Nm of torque currently available for supply. Therefore, if the powertrain 400 were to supply the up to +120 Nm of additional torque, there may for example be a risk of the vehicle 10 losing traction on the current driving surface.

The transmission control module 110b (or, in some embodiments, the powertrain control module 110a) may then adjust the upper limit 550a such that the upper limit 550a of available torque is capped at the maximum limit of the demand for stability control intervention (i.e. +10 Nm).

As a result, any increase in torque supplied by the powertrain 400 whilst the demand for stability control intervention is in effect will not then result in a risk of loss of traction, and the drivability of the vehicle 10 is maintained.

In some embodiments, the upper limit 550a or lower limit 550b may be calculated by the powertrain control module 110a based on an existing demand for stability control intervention (i.e. where a maximum or minimum torque value has already been received as part of a demand for stability control intervention). Alternatively, in some embodiments, the powertrain control module 110a or the transmission control module 110b of the one or more controllers 115 may adjust the upper limit 550a or the lower limit 550b based on a received demand for stability control intervention after they are calculated.

In some embodiments, the transmission control module 110b or the powertrain control module 110a may set the upper limit 550a and/or the lower limit 550b to zero (i.e. no change in torque) in the presence of a demand for stability control intervention.

The discussion below, with reference to FIGS. 5 and 6, concerns examples of how the powertrain control module 110a may calculate the upper limit 550a and lower limit 550b of the torque currently available for supply by the powertrain 400. One or both of the methods of FIGS. 5 and 6 may be carried out by the powertrain control module 110a concurrently or successively, depending on specific requirements and circumstances.

It will be understood that the specific methods described with reference to FIGS. 5 and 6 are merely examples, and that certain steps may be altered or replaced with other steps as appropriate in specific circumstances and for specific vehicles (e.g. where the vehicle 10 is a battery electric vehicle (BEV), or is a fully internal combustion engine vehicle (ICEV)).

FIG. 5 shows a method 1000 by which the powertrain control module 110a calculates the upper limit 550a of currently available (i.e. the maximum currently available) torque for supply by the powertrain 400. It will be understood that the method 1000 of FIG. 5 may be carried out before a torque intervention request is received (i.e. before time t=a in FIG. 4), or in response to a torque intervention being received (i.e. at time t=a, or just prior to time t=a in FIG. 4).

At step 1050, the torque availability data 500 is collected for each actuator of the plurality of actuators 200. As discussed above, each torque actuator of the plurality of torque actuators 200 may collect torque availability data 500 continuously (i.e. in real time), for instance every time a certain predetermined period of time has elapsed.

The torque availability data 500 received by the powertrain control module 110a may include the maximum currently available torque that can be delivered by the internal combustion engine 200a. This may take the form of a single value of available torque, or may take the form of multiple currently available torque values. For example, in some embodiments the torque availability data 500 may include the maximum currently available torque that can be supplied by the internal combustion engine 200a expressed as a maximum available engine fast torque (e.g. a quickly attainable naturally aspirated torque from the engine), and a maximum available engine slow torque (e.g. a more slowly attainable turbo-charged torque from the engine, where the engine has a turbo).

In such scenarios, in step 1100 the powertrain control module 110a may then make a calibratable selection of the maximum available engine fast torque and the maximum available engine slow torque, to produce a single value for the available torque from this actuator of the plurality of actuators 200.

It will be understood that, although FIG. 5 shows the inclusion in step 1100 of both a maximum available engine fast torque and a maximum available engine slow torque, this may take the form of a single value of currently available torque that can be supplied by the internal combustion engine 200a (as discussed above). In such scenarios, no calibratable selection is needed, and this single value of the maximum currently available torque that can be delivered by the internal combustion engine 200a can be processed further in step 1150.

In some embodiments, the torque availability data 500 received by the powertrain control module 110a may also include the current engine clutch torque capacity. The current engine clutch torque capacity may be determined based on clutch shaping where the amount of torque supplied by the engine may be a change in torque over an extended period of time (e.g. 500 Nm/s for several seconds), as opposed to a change in the level of torque over a short period (e.g. from 200 Nm to 1000 Nm near instantaneously).

In such embodiments, the powertrain control module 110a may then in step 1150 select the minimum torque availability value between this current engine clutch torque capacity and the selection in step 1100 between the maximum available engine fast torque and the maximum available engine slow torque.

Alternatively, in those embodiments where a single value of the maximum currently available torque that can be supplied by the internal combustion engine 200a is provided, the powertrain control module 110a may in step 1150 select the minimum value between this current engine clutch torque capacity and that value of maximum currently available torque that can be supplied by the internal combustion engine 200a.

In some embodiments, the torque availability data 500 received by the powertrain control module 110a may also include the current maximum torque that can be delivered by the electric machine 200b (i.e. in a case where the vehicle 10 is an electric vehicle or a hybrid vehicle, or any other vehicle comprising an electric machine or motor).

In those embodiments in which the torque availability data 500 received by the powertrain control module 110a includes the current maximum torque that can be delivered by the electric machine 200b, in step 1200 this value may be added to the torque value produced in step 1150.

In some embodiments, the torque availability data 500 received by the powertrain control module 110a may also include the current maximum combined torque that can be delivered by the powertrain 400. In these embodiments, in step 1250 the lower value is selected between the value produced in step 1200 and the current maximum combined torque that can be delivered by the powertrain 400.

In some embodiments, the value produced in step 1250 is then processed in step 1300 as part of an arbitration based on the current engine clutch state. This arbitration in step 1300 may include one or more of the minimum currently available torque from the electric machine (i.e. the electric motor) 200b, the maximum currently available torque from the electric machine, the current engine clutch state, and the engine clutch torque capacity with internal shaping.

Then, in some embodiments, in step 1350 this value is compared with any currently necessary stability control interventions (or chassis control interventions). If a stability control intervention is required, the lower value between the maximum of this required stability control intervention and the output from step 1300 is selected. That is to say, if a stability control intervention is required where the maximum value of the required torque for that stability control intervention is less than the value provided by step 1300, then the powertrain control module 110a selects that value of the required torque for the stability control intervention.

Then, in some embodiments, in step 1400 the sign of the resulting torque availability value may be inverted if necessary.

Finally, in step 1450, this value (either from step 1350, or if necessary, from step 1400, as discussed above) is output from the powertrain control module 110a as the upper limit 550a of the currently available torque for supply by the powertrain 400.

As discussed above, this upper limit 550a of the currently available torque for supply by the powertrain 400 may be expressed as an absolute value or as a relative value, as needed.

It will be appreciated that the powertrain control module 110a may implement all or some of the steps discussed above and as shown in FIG. 5, depending on the specific scenario as well as the specific vehicle 10 in question. For example, where the vehicle 10 in question is not an electric or hybrid vehicle, the powertrain control module 110a may forego step 1200 related to the maximum currently available torque of the electric machine (or electric motor) 200b, and instead proceed directly to the next step in question.

Once the upper limit 550a, or maximum currently available torque, is calculated, the powertrain control module 110a provides the upper limit 550a value to the transmission control module 110b.

FIG. 6 shows a method 2000 by which the powertrain control module 110a calculates the lower limit 550b of currently available (i.e. the minimum currently available) torque for supply by the powertrain 400. It will be understood that the method 2000 of FIG. 6 may be carried out before a torque intervention request is received (i.e. before time t=a in FIG. 4), or in response to a torque intervention being received (i.e. at time t=a, or just prior to time t=a in FIG. 4).

At step 2050, the torque availability data 500 is collected for each actuator of the plurality of actuators 200. This may be in the same manner as for step 1050 of the method 1000 as shown in FIG. 5. As discussed above, each torque actuator of the plurality of torque actuators 200 may collect torque availability data 500 continuously (i.e. in real time), for instance every time a certain predetermined period of time has elapsed.

Here, the torque availability data 500 received by the powertrain control module 110a may include the minimum currently available torque that can be delivered by the internal combustion engine 200a. This may take the form of a single value of available torque. In some embodiments, the minimum currently available torque that can be delivered by the internal combustion engine 200a included in the torque availability data 500 may reflect the internal combustion engine 200a being in a fuel-cut (i.e. no fuel-being injected into the engine) or firing state (i.e. when fuel is being injected into the engine). This therefore accounts for different possible engine controls and states during the transmission torque intervention.

In some embodiments, the torque availability data 500 received by the powertrain control module 110a may further include the minimum currently available torque that can be delivered by the electric machine (or electric motor) 200b.

At step 2100, the sum of the minimum currently available torque that can be delivered by the internal combustion engine 200a and the minimum currently available torque that can be delivered by the electric machine (or electric motor) 200b is calculated.

In some embodiments, the torque availability data 500 received by the powertrain control module 110a may also include the current minimum combined torque that can be delivered by the powertrain 400. In these embodiments, in step 2150 the maximum between the value produced in step 2100 and the current minimum combined torque that can be delivered by the powertrain 400 may be selected.

In some embodiments, the value produced in step 2150 is then processed in step 2200 as part of an arbitration based on the current engine clutch state. This arbitration in step 2200 may include one or more of the minimum currently available torque from the electric machine (or the electric motor), the maximum currently available torque from the electric machine, the current engine clutch state, and the engine clutch torque capacity with internal shaping. This may be substantially in the same manner as for step 1300 of the method 1000 as shown in FIG. 5.

Then, in some embodiments, in step 2250 this value is compared with any currently necessary stability control interventions (or chassis control interventions). If a stability control intervention is required, the higher value between the required stability control intervention and the output from step 2200 is selected. That is to say, if a stability control intervention is required where the minimum value of the required torque for that stability control intervention is greater than the value provided in step 2200, then the powertrain control module 110a selects that value of the required torque for the stability control intervention.

In some embodiments, the powertrain control module 110a may set the lower limit 550b of the currently available torque for supply by the powertrain 400 to zero in the presence of a stability control intervention. In such scenarios, the torque supplied by the powertrain 400 cannot be decreased (since the lower limit 550b is set to zero), despite any request for torque intervention, in order to ensure that there is no risk of loss of traction, and the drivability of the vehicle 10 is maintained.

In embodiments where the lower limit 550b is expressed as a relative value, in step 2300 the value from step 2250 may be converted to a relative value using the current combined torque being delivered by the powertrain 200a. That is to say, the torque currently being delivered by the powertrain 400, when there is no torque intervention taking place, may be used in step 2300 to convert the output of step 2250 to a relative value.

Then, in some embodiments, in step 2350 the sign of the torque availability value resulting from step 2300 (or step 2250 where the lower limit 550b is not a relative value) may be inverted if necessary. This may be necessary in scenarios in which, in some vehicles, the negative limit is expected to be negative for one vehicle application (or system of the vehicle), but for another vehicle application (or system of the vehicle) this may require positive values.

Finally, in step 2400, this value (either from step 2350, or in some embodiments, from step 2300) is output from the powertrain control module 110a as the lower limit 550b of the currently available torque for supply by the powertrain 400.

As discussed above with reference to step 2300, this lower limit 550b of the currently available torque for supply by the powertrain 400 may be expressed as an absolute value or a relative value, as needed.

It will be appreciated that the powertrain control module 110a may implement all or some of the steps discussed above and shown in FIG. 6, depending on the specific scenario as well as the specific vehicle in question. For example, where the vehicle 10 in question is not an electric or hybrid vehicle, the powertrain control module 110a may forego step 2100 related to the minimum currently available torque of the electric machine (or electric motor) 200b, and instead proceed directly to the next step in question.

Once the lower limit 550b, or minimum currently available torque, is calculated, the powertrain control module 110a provides the lower limit 550b value to the transmission control module 110b.

FIGS. 3 and 4, and the corresponding discussion above, therefore allows the powertrain control module 110a to provide the transmission control module 110b with the upper limit 550a and lower limit 550b of the currently available torque that can be delivered by the powertrain 400. The therefore allows the transmission control module 110b to adjust any received request for torque intervention (e.g. a request for a gear shift) such that the resulting increase or decrease in torque supplied by the powertrain does not exceed the upper limit 550a or lower limit 550b of the torque that is current available for supply. This then improves the control and quality of the gear shift, and improves the overall drivability of the vehicle 10.

FIG. 7 shows a flowchart of a method 3000 of the function of the control system 100 according to some embodiments. In particular, the method 3000 of FIG. 7 is a method of operating a control system 100 of a vehicle 10 for managing the torque of the vehicle 10. It will be understood that steps 3050 to 3250 of the method 3000 of FIG. 7 may be carried out before a torque intervention request is received (i.e. before time t=a in FIG. 4), or in response to a torque intervention being received (i.e. at time t=a, or just prior to time t=a in FIG. 4).

The method 3000 may be performed by the control system 100 as illustrated in FIG. 3. In particular, the memory 130 may comprise computer-readable instructions which, when executed by the processor 120, perform the method 3000 according to an embodiment of the invention.

At step 3050, during a predetermined time period, torque availability data 500 is collected from each actuator of the plurality of actuators 200 of the powertrain 400 (or power source).

At step 3100, the torque availability data 500 is then provided to the powertrain control module 110a. It will be understood that the powertrain control module 110a may also be referred to as the first control module. The torque availability data 500 received at the powertrain control module 110a (or first control module) is therefore representative of the amount of torque available for supply by a propulsion system of the vehicle within the predetermined time period.

At step 3150, the powertrain control module 110a (or first control module) calculates the upper limit 550a of the torque available for torque intervention during the predetermined time period based on the torque availability data 500.

At step 3200, the powertrain control module 110a (or first control module) calculates the lower limit 550b of the torque available for torque intervention during the predetermined time period based on the torque availability data 500.

In some embodiments, one or both of steps 3150 and 3200 may be carried out, depending on the specific requirements of the scenario.

At step 3250, the powertrain control module 110a (or first control module) then provides the calculated upper limit 550a and/or the calculated lower limit 550b to the transmission control module 110b. As discussed above, it will be understood that the transmission control module 110b may also be referred to as the second control module.

In some embodiments, the following steps from step 3300 onwards may be considered optional. At step 3300, the transmission control module 110b (or second control module) may then receive a torque intervention request to either increase or decrease the torque supplied by the powertrain 400 of the vehicle 10. In some embodiments, the transmission control module 110b (or second control module) may generate a torque intervention request (for example, in response to receiving a signal indicating a gear shift).

The torque intervention request may be received during the predetermined time period, or shortly after the predetermined time period (where a further upper limit 550a and lower limit 550b have not yet been received from the powertrain control module 110a). In some embodiments, the upper limit 550a and/or lower limit 550b may be determined and permanently set, based on an initial set of torque availability data 500.

In some embodiments, at step 3350 the transmission control module 110b (or second control module) may then determine whether the request to increase or decrease the torque supplied by the powertrain 400 of the vehicle 10 exceeds the upper limit 550a or the lower limit 550b of the torque available for supply.

In those embodiments where the transmission control module 110b (or second control module) determines at step 3350 that the request to increase or decrease the torque supplied by the powertrain 400 of the vehicle 10 does exceed the upper limit 550a or the lower limit 550b of the torque available for supply, the control system 100 continues to step 3400.

At step 3400, the transmission control module 110b (or second control module) may then adjust the torque intervention request based on the determination of step 3350, such that the request to either increase or decrease the torque supplied by the powertrain 400 of the vehicle does not exceed the upper limit 550a or the lower limit 550b of the torque available for supply.

At step 3450, the transmission control module 110b (or second control module) may then implement the adjusted torque intervention request to increase or decrease the torque supplied by the powertrain 400 of the vehicle 10.

As a result, since the adjusted torque intervention request does not exceed (i.e. falls between) the upper limit 550a and the lower limit 550b of the currently available torque that can be supplied by the powertrain 400, the control and quality of the resulting torque intervention (e.g. gear shift) is improved, thereby improving the overall drivability of the vehicle 10.

As discussed above, it will be appreciated that the term upper limit may also be understood to be an upper threshold. Likewise, it will be appreciated that the term lower limit may also be understood to be a lower threshold.

As discussed above, FIGS. 5 to 7 illustrate methods 1000, 2000, and 3000 described by flow charts 1000, 2000, and 3000 according to one or more embodiments of the invention. The methods 1000 and 2000 are methods for respectively calculating the upper limit 550a and lower limit 550b of the torque currently available for supply by the powertrain 400 during a current predetermined time period to implement a received torque intervention request in a vehicle 10, such as the vehicle 10 illustrated in FIG. 1. The method 3000 is a method for managing the torque supplied by the powertrain 400 of a vehicle 10 by calculating the upper limit 550a and lower limit 550b of the torque currently available for supply by the powertrain 400 to implement a received torque intervention request in the vehicle 10, such as the vehicle 10 illustrated in FIG. 1.

The methods 1000, 2000, and 3000 may be performed by the control system 100 illustrated in FIG. 3. In particular, the memory 130 may comprise computer-readable instructions which, when executed by the processor 110, perform one or more of the methods 1000, 2000, and 3000 according to one or more embodiments of the invention.

It will be appreciated that various changes and modifications can be made to the present invention without departing from the scope of the present application.

For purposes of this disclosure, it is to be understood that reference to ‘the control system being configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

1. A control system for managing the torque of a vehicle, the control system comprising one or more controllers, and wherein the control system is configured to:
receive, at the one or more controllers, torque availability data representative of an amount of torque available for supply by a propulsion system of the vehicle within a predetermined time period;
calculate, by the one or more controllers, at least one of an upper limit of the torque available for torque intervention during the predetermined time period based on the torque availability data, or a lower limit of the torque available for torque intervention during the predetermined time period based on the torque availability data;
receive, at the one or more controllers, a torque intervention request comprising a request to either increase or decrease the torque supplied by the propulsion system of the vehicle during the predetermined time period;
determine, by the one or more controllers, whether the request to increase or decrease the torque supplied by the propulsion system of the vehicle during the predetermined time period exceeds the at least one of the upper limit or the lower limit of the torque available for supply by the propulsion system of the vehicle;
adjust, by the one or more controllers and based on the determination, the torque intervention request such that the request to either increase or decrease the torque supplied by the propulsion system of the vehicle does not exceed the at least one of the upper limit or the lower limit of the torque available for supply by the propulsion system of the vehicle during the predetermined time period; and
implement, by the one or more controllers, the adjusted torque intervention request to increase or decrease the torque supplied by the propulsion system of the vehicle during the predetermined time period.

2. The control system of claim 1, wherein the one or more controllers comprises a first control module and a second control module, and wherein:
the first control module is configured to receive the torque availability data, and calculate the at least one of the upper limit or the lower limit of the torque available for supply by the propulsion system of the vehicle based on the torque availability data; and
the second control module is configured to receive the torque intervention request, determine whether the request to increase or decrease the torque supplied by the propulsion system of the vehicle during the predetermined time period exceeds the at least one of the upper limit or the lower limit, adjust the torque intervention request based on the determination, and implement the adjusted torque intervention request.

3. The control system of claim 2, wherein the torque availability data comprises at least one of an upper limit of the torque that can be supplied by an electric motor of the propulsion system of the vehicle during the predetermined time period, and a lower limit of the torque that can be supplied by the electric motor of the propulsion system of the vehicle during the predetermined time period; and
the control system is further configured to calculate, by the first control module, at least one of:
the upper limit of the torque available for torque intervention based upon the upper limit of the torque that can be supplied by the electric motor of the propulsion system of the vehicle during the predetermined time period; and
the lower limit of the torque available for torque intervention based upon the lower limit of the torque that can be supplied by the electric motor of the propulsion system of the vehicle during the predetermined time period.

4. The control system of claim 2, wherein the torque availability data comprises at least one of an upper limit of the torque that can be supplied by an engine of the propulsion system of the vehicle during the predetermined time period, and a lower limit of the torque that can be supplied by the engine of the propulsion system of the vehicle during the predetermined time period; and
the control system is further configured to calculate, by the first control module, at least one of:
the upper limit of the torque available for torque intervention based upon the upper limit of the torque that can be supplied by the engine of the propulsion system of the vehicle during the predetermined time period; and
the lower limit of the torque available for torque intervention based upon the lower limit of the torque that can be supplied by the engine of the propulsion system of the vehicle during the predetermined time period.

5. The control system of claim 2, wherein the torque availability data comprises a state of a clutch of the vehicle during the predetermined time period; and
the control system is further configured to calculate, by the first control module, at least one of:
the upper limit of the torque available for torque intervention based upon the state of the clutch during the predetermined time period; and
the lower limit of the torque available for torque intervention based upon the state of the clutch during the predetermined time period.

6. The control system of claim 2, wherein the control system is further configured to:
receive, at the second control module, a stability control intervention demand to either increase or decrease the torque supplied by the propulsion system of the vehicle during the predetermined time period;
adjust, by the second control module, the at least one of the upper limit and the lower limit of the torque available for torque intervention during the predetermined time period such that the at least one of the upper limit and the lower limit of the torque available for torque intervention during the predetermined time period does not exceed the demand to either increase or decrease the torque supplied by the propulsion system of the vehicle in the stability control intervention; and
implement, by the second control module, the stability control intervention demand to increase or decrease the torque supplied by the propulsion system of the vehicle during the predetermined time period.

7. The control system of claim 2, wherein the control system is further configured to:
calculate the at least one of the upper limit of the torque available for torque intervention during the predetermined time period and the lower limit of the torque available for torque intervention during the predetermined time period as a relative value of the absolute torque that can be supplied by the propulsion system of the vehicle during the predetermined time period.

8. A vehicle comprising the control system of claim 1.

9. A method for managing the torque of a vehicle, the method comprising:
receiving torque availability data representative of an amount of torque available for supply by a propulsion system of the vehicle within a predetermined time period;
calculating at least one of an upper limit of the torque available for torque intervention during the predetermined time period based on the torque availability data, or a lower limit of the torque available for torque intervention during the predetermined time period based on the torque availability data;
receiving the at least one of the upper limit and the lower limit of the torque available for torque intervention during the predetermined time period;
receiving a torque intervention request comprising a request to either increase or decrease the torque supplied by the propulsion system of the vehicle during the predetermined time period;
determining whether the request to increase or decrease the torque supplied by the propulsion system of the vehicle during the predetermined time period exceeds the at least one of the upper limit or the lower limit of the torque available for supply by the propulsion system of the vehicle;
based on the determination, adjusting the torque intervention request such that the request to either increase or decrease the torque supplied by the propulsion system of the vehicle does not exceed the at least one of the upper limit or the lower limit of the torque available for supply by the propulsion system of the vehicle during the predetermined time period; and
implementing the adjusted torque intervention request to increase or decrease the torque supplied by the propulsion system of the vehicle during the predetermined time period.

10. The method of claim 9, wherein the torque availability data comprises at least one of an upper limit of the torque that can be supplied by an electric motor of the propulsion system of the vehicle during the predetermined time period, and a lower limit of the torque that can be supplied by the electric motor of the propulsion system of the vehicle during the predetermined time period; and
the method further comprises at least one of:
calculating the upper limit of the torque available for torque intervention based upon the upper limit of the torque that can be supplied by the electric motor of the propulsion system of the vehicle during the predetermined time period; and
calculating the lower limit of the torque available for torque intervention based upon the lower limit of the torque that can be supplied by the electric motor of the propulsion system of the vehicle during the predetermined time period.

11. The method of claim 9, wherein the torque availability data comprises at least one of an upper limit of the torque that can be supplied by an engine of the propulsion system of the vehicle during the predetermined time period, and a lower limit of the torque that can be supplied by the engine of the propulsion system of the vehicle during the predetermined time period; and
the method further comprises at least one of:
calculating the upper limit of the torque available for torque intervention based upon the upper limit of the torque that can be supplied by the engine of the propulsion system of the vehicle during the predetermined time period; and
calculating the lower limit of the torque available for torque intervention based upon the lower limit of the torque that can be supplied by the engine of the propulsion system of the vehicle during the predetermined time period.

12. The method of claim 9, wherein the torque availability data comprises a state of a clutch of the vehicle during the predetermined time period; and
the method further comprises at least one of:
calculating the upper limit of the torque available for torque intervention based upon the state of the clutch during the predetermined time period; and
calculating the lower limit of the torque available for torque intervention based upon the state of the clutch during the predetermined time period.

13. The method of claim 9, wherein the method further comprises:
receiving a stability control intervention demand to either increase or decrease the torque supplied by the propulsion system of the vehicle during the predetermined time period;
adjusting the at least one of the upper limit and the lower limit of the torque available for torque intervention during the predetermined time period such that the at least one of the upper limit and the lower limit of the torque available for torque intervention during the predetermined time period does not exceed the demand to either increase or decrease the torque supplied by the propulsion system of the vehicle in the stability control intervention; and
implementing the stability control intervention demand to increase or decrease the torque supplied by the propulsion system of the vehicle during the predetermined time period based on the adjusted at least one of the upper limit and lower limit of the torque available for torque intervention during the predetermined time period.

14. The method of claim 9, wherein the method further comprises:
calculating the at least one of the upper limit of the torque available for torque intervention during the predetermined time period and the lower limit of the torque available for torque intervention during the predetermined time period as a relative value of the absolute torque that can be supplied by the propulsion system of the vehicle during the predetermined time period.

15. Computer readable instructions which, when executed by a computer, are arranged to perform a method according to claim 9.
